(19) United States
(12) Patent Application Publication
(10) Pub. No.: US 2025/0205716 A1
(43) Pub. Date: Jun. 26, 2025

(54) DUAL SHOWER HEAD AND SIDE MISTER ASSEMBLIES

(71) Applicant: Jeffrey Dale Escoe, Joliet, IL (US)

(72) Inventor: Jeffrey Dale Escoe, Joliet, IL (US)

(21) Appl. No.: 18/991,241

(22) Filed: Dec. 20, 2024

Related U.S. Application Data
(60) Provisional application No. 63/612,464, filed on Dec. 20, 2023.

(51) Int. Cl. B05B 1/18; B05B 1/20; E03C 1/02; E03C 1/04

(52) U.S. Cl. CPC B05B 1/185; B05B 1/20; E03C 1/025; E03C 1/0408

(57) ABSTRACT

Dual shower head and side mister mounting assemblies and methods. The assembly includes a pair of mounting wall plates for mounting and stabilizing a water transfer conduit that transfers water flow from an existing shower head unit to an opposing second shower head unit mounted on an opposite wall, facing the existing shower head unit. The assembly can also include a pair of side misters mounted between the wall plates, and water is directed to the second shower head unit and/or the side misters through piping housed within the wall plate opposite the existing shower head unit. The proximal and distal ends of the side misters can be connected to each other by pressure relief piping segments housed within each wall plate to form a continuous pressure-equalizing conduit loop. A light source can be mounted under a top panel or hood connected between the wall plates.

### CROSS-REFERENCE

This application claims the priority benefit of U.S. Provisional Patent Application No. 63/612,464, filed Dec. 20, 2023, entitled DUAL SHOWER HEAD MOUNTING ASSEMBLY AND METHOD, which is hereby incorporated herein for all purposes in its entirety.

### FIELD OF THE DISCLOSURE

The present disclosure relates to an assembly that adds one or more additional spray heads to an existing shower with an existing shower head unit connected to a single supply line. More particularly, it relates to an assembly that adds an opposed, second shower head unit on an opposite wall. Still more particularly, it relates to an assembly that adds such an opposed second shower head and a pair of side-mister units extending between the opposite walls.

### SUMMARY

In accordance with an aspect of the present disclosure, a dual shower head assembly comprises a first shower head unit, a transfer unit, a distal wall plate, distal piping, and a second shower head unit. The first shower head unit comprises a first shower head, the first shower head unit being disposed on a proximal bathroom wall and fluidly connected to a shower supply line. The transfer unit is fluidly connected to the first shower head unit between the shower supply line and the first shower head. The distal wall plate is disposed on a distal bathroom wall opposite and spaced in a distal longitudinal direction from the proximal bathroom wall. The distal piping is retained by the distal wall plate, the distal piping comprising a transfer inlet, a shower outlet, and a shower feed flow channel extending from the transfer inlet to the shower outlet. The transfer unit is fluidly connected to the transfer inlet. The second shower head unit comprises a second shower head and is fluidly connected to the shower outlet.

### BRIEF DESCRIPTION OF THE DRAWINGS

Although the characteristic features of this disclosure will be particularly pointed out in the claims, the disclosed method and system, and how it may be made and used, may be better understood by referring to the following description taken in connection with the accompanying drawings forming a part hereof, wherein like reference numerals refer to like parts throughout the several views and in which:

FIG. 1 is a top-side perspective view of a dual shower head mounting assembly according to an embodiment, viewed from an open side of a shower-bath unit.

FIG. 2 is an enlarged longitudinal cross-sectional view of a connector connecting a spacer to a water transfer pipe in the assembly of FIG. 1.

FIG. 3 is a plan view of an outward-facing side of a wall plate of the assembly of FIG. 1.

FIG. 4 is a top-rear-side perspective view of the wall plate of FIG. 3, showing an integrally retained conduit segment.

FIG. 5 is a plan view of an outward-facing side of another wall plate of the assembly of FIG. 1.

FIG. 6 is a top-side perspective view of the dual shower head mounting assembly of FIG. 1, modified to include a top panel for a light fixture according to another embodiment.

FIG. 7 is a top plan view of another embodiment of a dual shower head mounting assembly.

FIG. 8 is a top-side perspective view of a dual shower head mounting assembly according to another embodiment, viewed from an open side of a shower-bath unit.

FIG. 9 is a top-side perspective view of a dual shower head and side mister mounting assembly according to another embodiment, viewed from an open side of a shower-bath unit.

FIG. 10 is a bottom-left-proximal perspective view of a distal end portion of the dual shower head and side mister mounting assembly of FIG. 9, modified to include a lighted top panel subassembly according to another embodiment.

FIG. 11 is an exploded top-right-proximal perspective view of a proximal end portion of the dual shower head and side mister mounting assembly of FIG. 9, with a proximal panel of a proximal wall plate rotated ninety degrees from the exploding axis to show its distal side.

FIG. 12 is a distal plan view of a proximal panel of a distal wall plate of the dual shower head and side mister mounting assembly of FIG. 9 with a distal panel of the distal wall plate removed to reveal piping enclosed within the distal wall plate.

FIG. 13 is proximal plan view of the distal wall plate proximal panel of FIG. 12 showing the positions of holes for connecting a water transfer pipe, a second shower head, and a pair of opposed side misters to the enclosed piping.

FIG. 14 is a proximal plan view of a distal panel corresponding to the distal wall plate proximal panel of FIGS. 12 and 13.

A person of ordinary skill in the art will appreciate that elements of the figures above are illustrated for simplicity and clarity and are not necessarily drawn to scale. The dimensions of some elements in the figures may have been exaggerated relative to other elements to help to understand the present teachings. Furthermore, a particular order in which certain elements, parts, components, modules, steps, actions, events and/or processes are described or illustrated may not be required. A person of ordinary skill in the art will appreciate that, for simplicity and clarity of illustration, some commonly known and well-understood elements that are useful and/or necessary in a commercially feasible embodiment may not be depicted to provide a clear view of various embodiments per the present teachings.

### DETAILED DESCRIPTION

In the following description of various examples of embodiments of the disclosed dual shower head and side mister mounting assemblies, reference is made to the accompanying drawings, which form a part hereof, and in which are shown by way of illustration various examples of the disclosed subject matter. Other specific arrangements of parts, example devices, systems, and environments, can be used, and structural modifications and functional modifications can be made without departing from the scope of the disclosed subject matter.

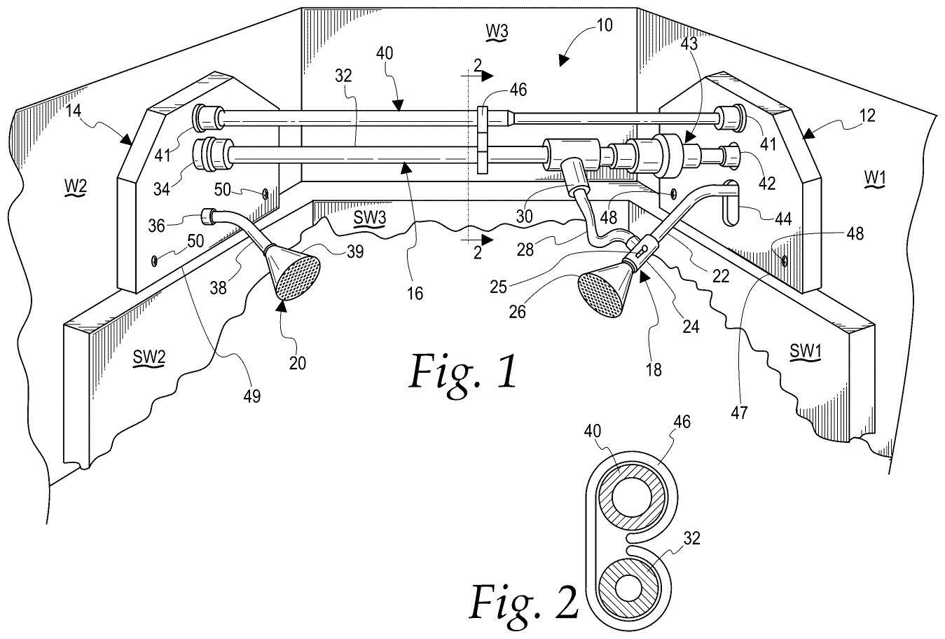

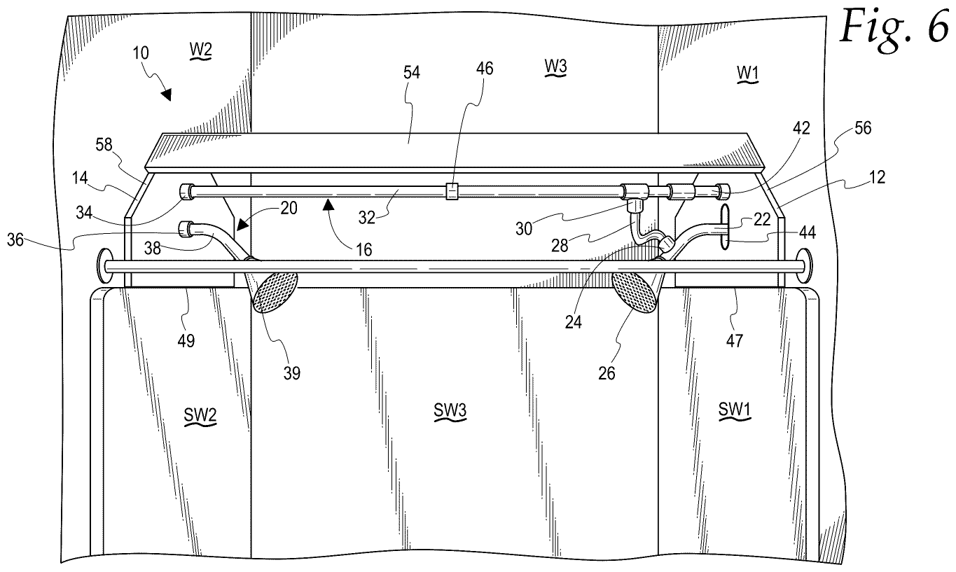

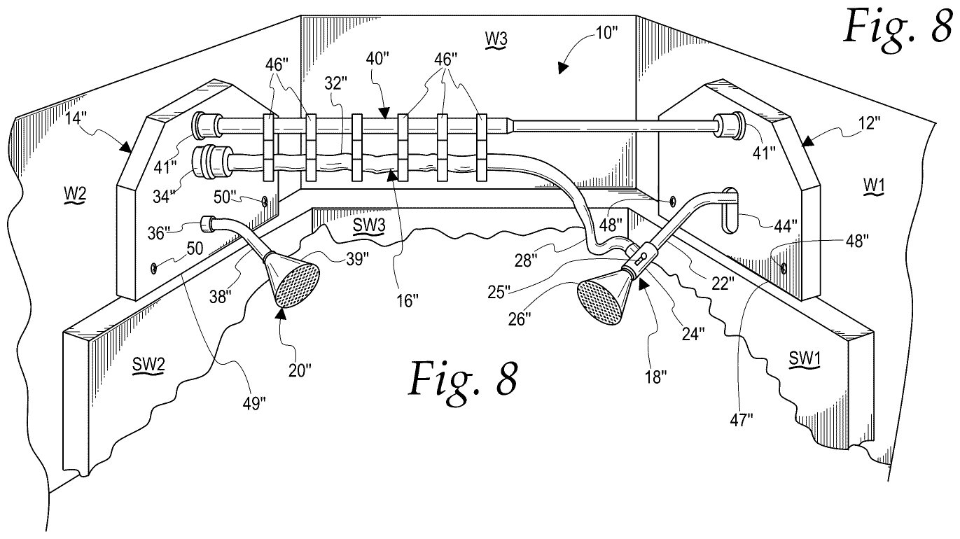

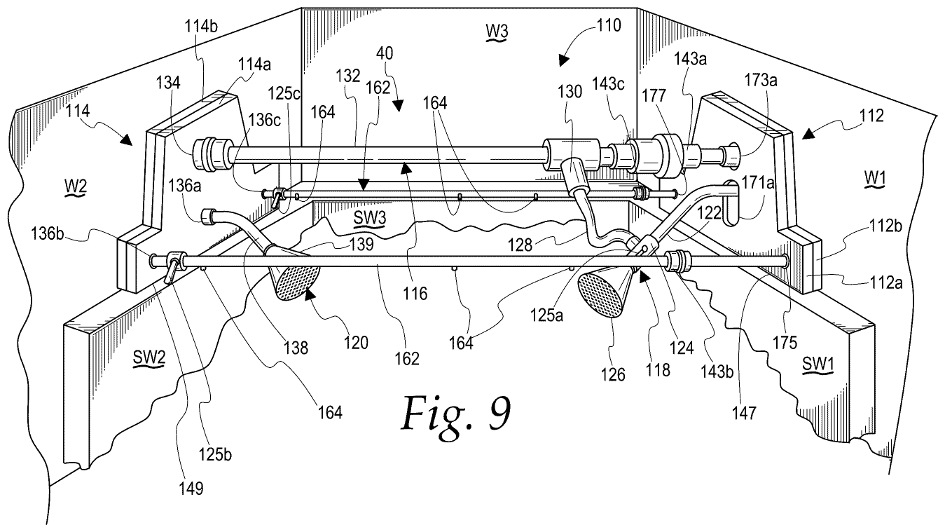

Dual shower head and/or side-mister mounting assemblies that convert an existing shower according to several embodiments are illustrated in the drawing figures and described in detail in this section. Each embodiment features a pair of opposed mounting wall plates, one disposed on a shower wall at the location of an existing shower head, and the other disposed on an opposite shower wall for mounting a second shower head. In each embodiment, a water transfer conduit diverts water flow from the existing shower head unit to an inlet of piping that extends through the interior of the opposite wall plate, which in turn directs the flow to its outlet where the second shower head is connected. A dual shower head mounting assembly 10 according to one embodiment is illustrated in FIGS. 1-6. Further illustrated in FIG. 6 is another embodiment in which the dual shower head mounting assembly 10 is modified by the addition of a top panel that can serve as a light fixture, stabilizing member, and/or steam hood. A dual shower head mounting assembly 10′ according to another embodiment is illustrated in FIG. 7, in which a water transfer pipe is supported along the three walls of a shower for stability. In another embodiment shown in FIG. 8, a dual shower head mounting assembly 10″ incorporates a flexible hose as a water transfer conduit, which is secured to an overhead spacer bar by a plurality of connectors distributed along its length. According to yet another embodiment illustrated in FIGS. 9-14, a dual shower head and side mister mounting assembly 110 further incorporates a pair of side misters extending along opposite sides of a water transfer pipe, and the opposite wall plate divides the flow into three branches directed to three outlets corresponding, respectively, to the second shower head and the side misters.

A dual shower head mounting assembly 10 according to an embodiment will now be described, with reference to FIGS. 1-7. As shown in FIG. 1, the assembly 10 provides for transfer of water flow from a first shower wall SW1 on a first bathroom wall W1, where an existing first shower head is located, to a second shower wall SW2 opposite the first shower wall SW1, the second shower wall SW2 being on a bathroom wall W2 opposite the first bathroom wall W1, to supply the water flow to a second shower head. In the typical use setting for the assembly 10, as illustrated in FIG. 1, a shower can have a third shower wall SW3 that extends from the first shower wall SW1 to the second shower wall SW2, the third shower wall SW3 being disposed on a third bathroom wall W3 that extends from the first bathroom wall W1 to the second bathroom wall W2, so that the shower walls SW1-SW3 form a continuous border around three perpendicular sides of a shower interior space, while the bathroom walls W1-W3 similarly form a continuous border around three perpendicular sides of the shower. As illustrated, the shower walls SW1, SW2, SW3 are comprised in a unitary wall panel. In other embodiments, the assembly 10 can be installed in a shower with tiled walls. In any case, the assembly 10 is generally intended for use in a combination shower/bath having an open side that extends along a long side of a bathtub opposite the third shower wall. However, it will be understood that the drawings are not necessarily to scale, and particularly in FIG. 1, the spans of the third bathroom wall W3 and third shower wall SW3 are shown as being relatively shorter than contemplated for a typical use setting so that the details of the assembly 10 may be enlarged for ease of illustration.

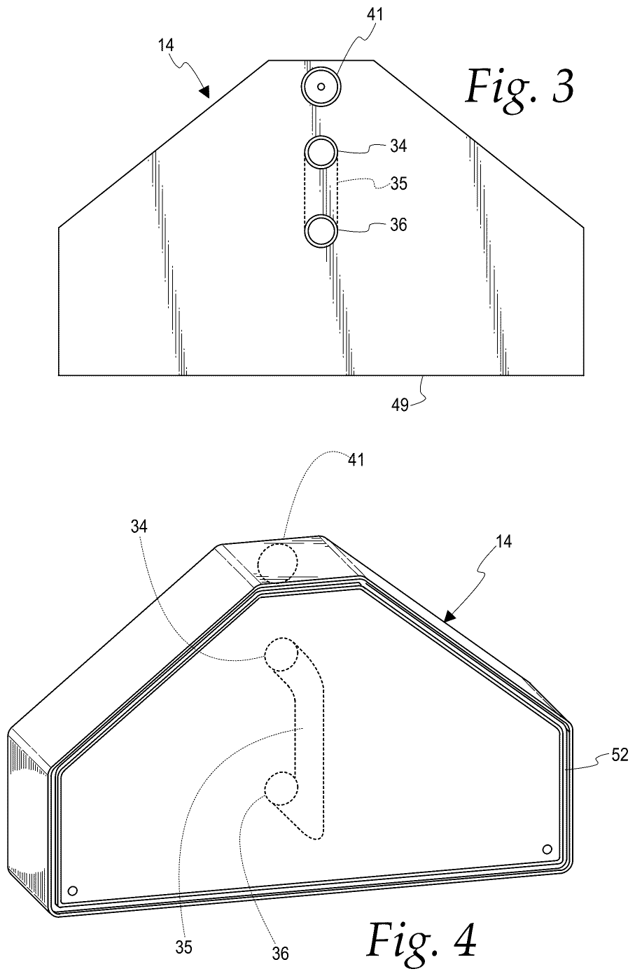

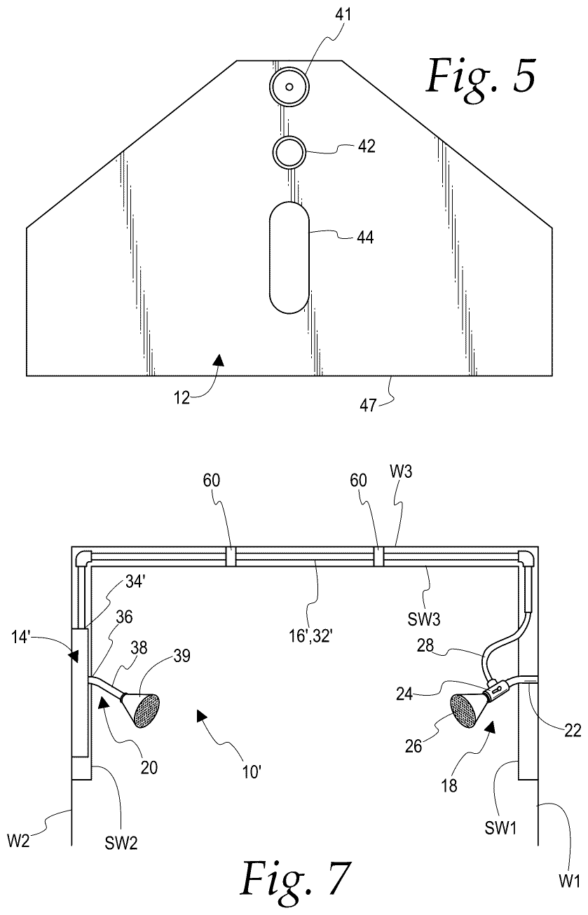

The construction of a water flow pathway of the assembly 10 will now be described in detail, with reference to FIG. 1 in particular. The assembly 10 includes a first wall plate 12, also referred to as a proximal wall plate (detail of an outer-facing side of which is shown in FIG. 5), mounted to the first (or proximal) bathroom wall W1, a second (or distal) wall plate 14 (shown in detail in FIGS. 3 and 4) mounted to the second (or distal) bathroom wall W2, and a transfer unit 16 supported between the wall plates 12, 14. The transfer unit 16 is operative to receive water transfer flow from a first shower head unit 18 and to direct the water transfer flow through the second wall plate 14 to a second shower head unit 20. More particularly, the first shower head unit 18 extends from the first bathroom wall W1 and has a first shower arm 22 connected to a water supply line, a three-way diverter valve junction 24 connected to the first shower arm 22, and a first shower head 26 connected to the valve junction 24. The valve junction 24 has a manual actuator 25 (shown as a lever) for setting the valve to direct water to flow out of a selected one of or both shower head units 18, 20. (In other embodiments, a simple shut-off valve can be provided on one or both shower head units.) A flexible hose 28 is connected between the valve junction 24 and a joint 30, the joint 30 in turn being connected to a transfer pipe 32 of the transfer unit 16. The joint 30 is shown as a T-joint; however, in other embodiments not shown, an elbow joint can be substituted for the joint 30, or a continuous pipe of a transfer unit with an elbow bend can be substituted for the joint 30 and the transfer pipe 32. The transfer pipe 32 connects to a transfer inlet 34, which in turn feeds the transfer flow to a shower outlet 36, the transfer inlet 34 and shower outlet 36 being retained by the second wall plate 14 and disposed so as to face the first wall plate 12 and the first bathroom wall W1 when the second wall plate 14 is mounted to the second bathroom wall W2. Retained in and extending into and out of the second wall plate 14 is an embedded U-bend pipe segment 35 (depicted in dashed lines in FIGS. 3-4). The embedded U-bend pipe segment 35 comprises the transfer inlet 34 and the shower outlet 36 and directs water flow from the transfer inlet 34 to the shower outlet 36. In this manner, the assembly 10 is said to provide “wall-to-wall” water transfer, in that water is transferred to the pipe segment 35 which is entirely disposed within a distance of less than or equal to the thickness of the second wall plate 14 from the second wall W2, which is for example less than 1 inch, or more particularly approximately 0.75 inch. The second shower head unit 20 includes a second shower arm 38 and a second shower head 39, the second shower arm 38 being connected between the shower outlet 36 and the second shower head 39, thereby completing the transfer flow path from the first shower head unit 18 to the second shower head 39.

The assembly 10 further includes components and features for mounting and stability as will now be described. First, an adjustable-length spacer bar 40 is positioned to extend from the first wall plate 12 to the second wall plate 14 and loaded in compression so as to provide outward longitudinal forces tending to hold the wall plates 12, 14 in place against the corresponding walls W1, W2. The spacer bar 40 is supported at each end by a respective spacer mounting seat 41 disposed on the side of the respective mounting plate 12, 14 facing away from the corresponding wall W1, W2. The spacer bar 40 can be, for example, a standard tension rod or equivalent or analogous component, of a type commonly used as a shower curtain rod, which may have an internal spring element (not shown) to bias its ends against the opposite wall plates 12, 14, thus permitting a user to press its two ends towards each other before positioning the spacer bar 40 in alignment with the two spacer mounting seats 41 and then to release the two ends to permit the spring to maintain the separation, and/or which provides for locking extension in place by twisting one of its two ends relative to the other to force the two ends to move apart from each other, such as by means of an internal helical thread or helical cam connection. As shown in the drawings, each spacer mounting seat 41 comprises a bushing (in alternative embodiments, a spacer mounting seat could be a recessed cavity in a wall plate) protruding outwardly from the wall plate 12, 14 away from the respective wall, and is offset from the position of the transfer inlet 34 of the second wall plate 14, so as to retain the spacer bar 40 offset from the transfer unit 16. More particularly, the spacer mounting seats 41 are offset above the transfer inlet 34 so as to retain the spacer bar 40 above the transfer unit 16. In other embodiments, a spacer can be retained between opposite wall plates at one or both sides of and/or below a transfer unit.

In addition to providing an outward force tending to hold the mounting plates 12, 14 against the respective walls W1, W2, the spacer bar 40 can also serve as a stabilizing support for a midsection of the transfer unit 16 during operation. That is, when the transfer pipe 32 is made of a plastic material such as CPVC or PEX, water flow through the transfer pipe 32 may produce forces tending to suddenly jostle the transfer pipe 32 in radial directions, particularly during a change in flow, such as when the water supply to the shower is turned on or off, or when the flow is redirected by a user changing the position of the valve actuator 25. To buffer or anchor the transfer pipe 32 against such radial jolting movements, the assembly 10 can include an anchoring connector 46 (shown in FIG. 1 and in more detail in FIG. 2) that connects to each of the spacer bar 40 and the transfer pipe 32 at an intermediate point along their respective lengths, so as to resist movements of the transfer pipe 32 toward and/or away from the spacer bar 40 in response to such internal shocks from change in water flow. On the other hand, when the transfer pipe 32 is made of a metallic material such as copper, chromed copper, or galvanized iron, its rigidity and mass may be sufficient to resist jostling from water flow without the need to be connected to the spacer bar 40 or otherwise anchored.

The first wall plate 12 also includes a transfer unit mounting seat 42, which is illustrated in FIG. 1 as a recessed cavity formed on its outward face. The mounting seat 42 is disposed in axial alignment with the transfer inlet 34 of the second wall plate 14, so that, when a first end of the transfer unit 16 is retained in the transfer unit mounting seat 42 and a second end of the transfer unit 16 is connected to the transfer inlet 34 (such as by threading the transfer pipe 32 onto the transfer inlet 34), the transfer unit 16 extends perpendicularly between the first and second wall plates 12, 14. A first end section of the transfer unit 16, which extends from the joint 30 to the first end, includes an extension adjustment component 43 (for example, a lockable slip joint) which is operable to extend the first end into the mounting seat 42 so as to hold the transfer unit 16 in alignment with the transfer inlet 34. Optionally, the first end of the transfer unit 16 and the mounting seat 42 can have complementary mating features (not shown), such as a circumferential groove around the first end of the transfer unit 16 receiving an upturned lip along a bottom edge of the mounting seat 42, to prevent the transfer unit 16 from being pulled out of the mounting seat 42 without first lifting the groove off of the lip. The first wall plate 12 further includes an elongate vertical shower arm slot 44 that is operative to fit around the first shower arm 22 so as to align the spacer mounting seat 41 and the transfer unit mounting seat 42, and thus the spacer bar 40 and the transfer unit 16, relative to the first shower arm 22, and more particularly so that they are offset vertically upward from the shower arm 22.

As mentioned above, the spacer bar 40 operates to provide a holding force pressing the wall plates 12, 14 against the corresponding walls W1, W2, thereby tending to secure the wall plates 12, 14 in place. In addition, the wall plates 12, 14 can be sized and shaped so that a respective bottom side 47, 49 of each wall plate 12, 14 abuts directly against a top side of the respective shower wall SW1, SW2 when the assembly 10 is installed, so as to prevent the wall plates 12, 14 from slipping down the respective walls W1, W2. Friction between each wall plate 12, 14 and the wall W1, W2 can resist or prevent horizontal sliding, as well as the shower arm slot 44 engaging the first shower arm 22 to hold the first wall plate 12 against horizontal movements away from its installed position.

Alternatively or in addition to being held by the compression force in the spacer bar 40, resulting friction with the respective bathroom wall W1, W2, and abutment against the shower walls SW1, SW2 and the first shower arm 22, either or both wall plates 12, 14 can be secured directly to the respective bathroom wall W1, W2, such as by suitable fasteners or adhesives. Thus, in the illustrated embodiment of the installed assembly 10 shown in FIG. 1, the wall plates 12, 14 are secured to the walls W1, W2 by respective mechanical fasteners (typically screws or bolts) 48, 50. In addition, the wall plates 12, 14 can include a peripheral adhesive channel on their respective wall-facing sides (illustrated in FIG. 4 for the second wall plate 14 as a channel 52) for applying a bead of a suitable adhesive (for example, Instant Nails® adhesive available from Sika Everbuild) prior to placing the wall plate 12, 14 against the respective wall surface and holding it in place by positioning the spacer bar 40 between the plates 12, 14 and/or by securing the fasteners 48,50.

Turning to FIG. 6, an embodiment of the assembly 10 further includes a top panel 54 that extends from the first wall W1 to the second wall W2, being fastened to a sloping top edge 56, 58, respectively, of the wall plates 12, 14. The top panel structure 54 can provide additional structural stability to the assembly 10, as well as forming a part of a steam hood and/or serving as a mount for a light source (hidden) on its underside, which may for example be a low-power, cordless light source such as a battery-powered LED strip. In embodiments, a horizontal top panel and a second inclined top panel, hidden in FIG. 6, similar or identical to the top panel structure 54, can be fastened to the middle horizontal top edges and to the descending sloping top edges of the wall plates 12, 14 facing the third bathroom wall W3, respectively. In other embodiments not shown, the transfer unit 16 and spacer bar 40 can be fully enclosed. For example, a single molded piece can incorporate wall plates analogous to the wall plates 12 and 14 with continuous top and side panels connected between them, forming a top cover with a bottom opening, which can be covered by a detachable translucent bottom panel to form a sealed enclosure to keep an enclosed light source and its power circuit dry during use of the shower.

Turning to FIG. 7, a dual shower head mounting assembly 10′ according to another embodiment is illustrated, in which like features to the assembly 10 are indicated by the same reference signs, and analogous, distinguishing features are indicated by the same reference signs with an appended prime symbol (′). The assembly 10′ is operative to transfer water from a first shower head unit 18, comprising a first shower arm 22, a valve junction 24, and a first shower head 26 as described previously, to a second shower head unit 20, which in turn comprises a second shower arm 38 and a second shower head 39 as previously described. Unlike the assembly 10, the assembly 10′ excludes a wall plate on the first wall W1 and includes only a wall plate 14′ on the second wall W2. The wall plate 14′ has a shower outlet 36 similar to that of the wall plate 14 and a transfer inlet 34′, the transfer inlet 34′ differing from that of the wall plate 14 in that it is disposed on a lateral side of the wall plate 14′ that faces along the second wall W2 toward the third wall W3, instead of outwardly away from the second wall W2.

A transfer pipe 32′ of a transfer unit 16′ has a first end connected to the valve junction 24 via the flexible hose 28 and a second end connected to the transfer inlet 34′ directly above the top side of the second shower wall SW2. This permits substantially the entire length of the transfer pipe 32′ to rest directly on the top sides of the shower walls SW1-SW3. For example, the transfer inlet 34′ can be disposed approximately at the vertical level of the top side of the second shower wall SW2, or the transfer pipe 32′ can include suitable joints and/or bends (not shown) to connect it to the transfer inlet 34′ at a vertically offset level above the top sides of the shower walls, and the remainder of the transfer pipe 32′, extending from the joints and/or bends to the flexible hose 28, can be disposed directly on the top sides of the shower walls. Advantageously, this obviates the need for a wall plate at the first wall W1 to support the weight at one end of a transfer unit, as in the previously described embodiment, as substantially the entire weight of the transfer unit 16′ can be supported by the top sides of the shower walls. In addition, the transfer pipe 32′ is braced against shocks caused by uneven water pressure in radial directions by the walls W1-W3 and SW1-SW3 themselves, and the assembly 10′ further includes one or more wall-mounted clips 60 to secure the transfer pipe 32′ to the third bathroom wall W3. The wall plate 14′ can be connected to the second wall W2 by suitable fasteners and/or adhesives (not shown) in like manner to that described for the wall plate 14 of the previously described embodiment. Accordingly, a spacer analogous to the spacer bar 40 of the previous embodiment is excluded from the assembly 10′, as the transfer pipe 32′ is stabilized, and the wall plate 14′ secured, by other means.

With reference to FIG. 8, a dual shower head mounting assembly 10″ according to still another embodiment is illustrated, which features a flexible hose 28″ as a water transfer conduit. The flexible hose 28″ is analogously to the flexible hose 28 of the assemblies 10, 10′ shown in FIGS. 1, 7 in that it is connected to an existing shower head unit 18″ by a three-way diverter valve junction 24″. However, the flexible hose 28″ also comprises a water transfer hose 32″ extends all the way to a transfer inlet 34″ of a second wall plate 14″, being secured to a spacer bar 40″ at points along its length by connectors 46″. In addition, a first wall plate 12″ of the assembly 10″ need not include a transfer unit mounting seat 42 as in the previously described embodiments, as the assembly 10″ substitutes the water transfer hose 32″ for a rigid wall-to-wall water transfer pipe. Accordingly, a transfer unit mounting seat is omitted from the wall plate 12″ as shown in FIG. 8. The remaining components and features of the assembly 10″ can be nearly or completely identical to the analogous components and features of the preceding embodiments designated by like reference numerals.

Turning to FIGS. 9-14, a dual shower head and side mister mounting assembly 110 according to yet another embodiment is illustrated. Components and features of the assembly 110 that are analogous to components and features of the preceding embodiments are designated by the previous reference numeral incremented by one hundred. Thus, the assembly 110 includes a first wall plate 112 (a proximal wall plate) disposed over a first shower head unit 118 on a first (proximal) bathroom wall W1 and a second wall plate 114 (a distal wall plate) disposed over a second shower head unit 120 on a second (distal) bathroom wall W2 opposite the first wall W1. A transfer unit 116 extends distally from the first wall plate 112 to the second wall plate 114 and comprises a transfer pipe 132 that extends over a substantial distal region of the length of the transfer unit 116, from the second wall plate 114 toward the first wall plate 112. The first shower head unit 118 has a first shower arm 122 that connects to a shower supply line and feeds a first shower head 126. A three-way diverter valve junction 124 is connected between the first shower arm 122 and the first shower head 126, a flexible hose 128 being connected to a side outlet of the three-way diverter valve junction 124. The flexible hose 128 diverts water flow from the first shower head unit 118 through a joint 130 and into the transfer pipe 132.

The transfer pipe 132 is connected at a distal end to a transfer inlet 134 of the second wall plate 114, and water flow is directed from the transfer inlet 134 to each of a shower outlet 136a and first and second mister outlets 136b, and 136c, to which a second shower head unit 120 and a pair of side mister units 162 are respectively connected. The second shower head unit 120 has a second shower arm 138 that directs water to a second shower head 139. Each side mister unit 162 has a plurality of misting spray nozzles 164 distributed along its length, oriented to direct misting spray toward a central area of the shower that extends between the two side mister units 162. In the illustrated embodiment, each side mister unit 162 comprises three misting spray nozzles 164. In other embodiments, each side mister unit 162 can have more or fewer misting spray nozzles, such as one, two, four, or more than four misting spray nozzles. As with the transfer unit 16 described for the assembly 10 of a previously described embodiment, each of the transfer unit 116 and the side mister units 162 is extendable to accommodate different shower lengths between opposite shower walls SW1 and SW2, each comprising a respective extension adjustment component 143a, 143b, 143c.

As shown in FIG. 9, the assembly includes valve actuators 125a, 125b, and 125c for controlling the flow of water through the three-way diverter valve junction 124, and through a shut-off valve disposed at each of the shower outlet 136a and the first and second mister outlets 136b, 136c, respectively. Whereas the valve actuator 125a typically has four positions, to selectively permit flow to one, the other, both, or neither of the first shower head 126 and the water transfer pipe 132, each of the valve actuators 125b and 125c operates simply to open, close, or partially open or close a respective shut-off valve, to turn flow on and off and to adjust a rate of flow to the respective side mister 162. Although not shown, an additional shut-off valve can be connected between the shower outlet 136a and the second shower head unit 120, to provide the option of shutting off or reducing flow to the second shower head 139 without shutting off or reducing flow to either of the side mister units 162.

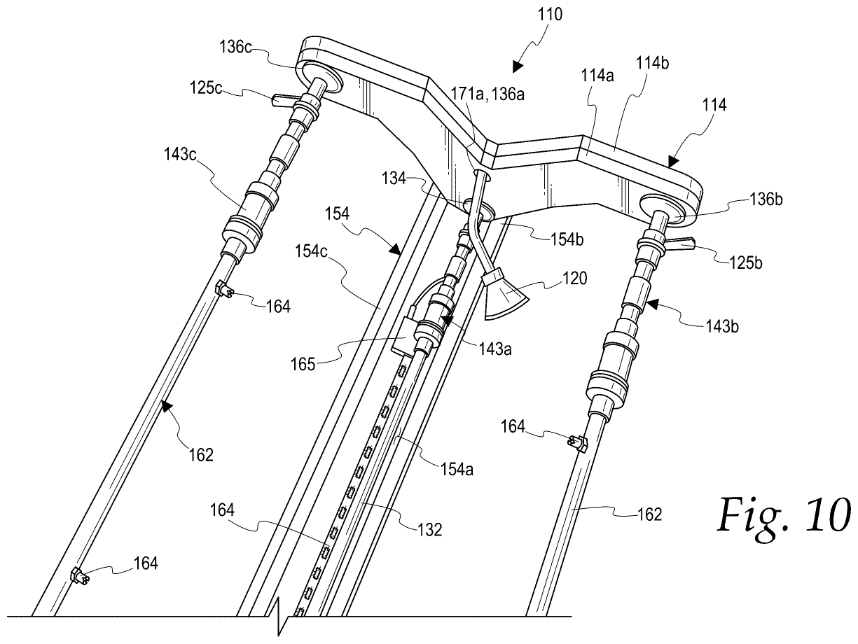

According to an embodiment illustrated in FIG. 10, an underside view of a distal, second end region of the assembly 110 shows the assembly 110 as modified by the addition of a top panel structure 154 analogous to the previously described top panel structure 54, constructed of a horizontal center panel 154a a pair of side panels 154b, 154c connected to and inclined downwardly and outwardly from opposite lateral sides of the center panel 154a. In other embodiments, the top panel structure 154 can be of one-piece construction, such as of molded plastic. The top panel structure 154 can provide benefits including adding structural stability to the assembly 110, as well as serving as a steam hood in embodiments, in conjunction with additional venting features and/or a fan (not shown). In addition, as previously mentioned but not shown for the top panel structure 54, the top panel structure 154 serves to mount a light source, illustrated as an LED strip 164 with a power supply 165, each affixed to the center panel 154a. Unless stated otherwise, it will be understood that any embodiment of a dual shower head assembly or dual shower head and side mister assembly according to this disclosure that is not shown to include and/or is not expressly described as including a top panel structure with a mounted light source as shown in FIG. 10 can be modified to include such a top panel structure, including, for example, the embodiments as shown in FIGS. 1, 6, 8, and 9.

Likewise, suitable moisture barriers can be included at appropriate inlet/outlet locations in any assembly according to this disclosure, for example, as shown at the locations of the transfer inlet 134 and the respective side mister outlets 136b, 136c, but removed at the location of the shower outlet 136a for the purpose of illustrating the front side of the corresponding hole 171a.

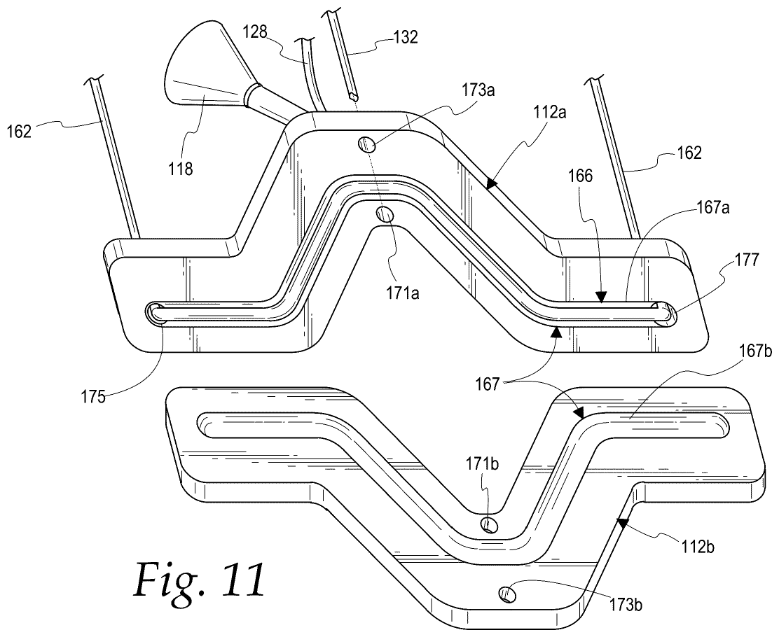

Each of the first and second wall plates 112, 114 is assembled in two clamshell halves, such as of molded plastic or other suitable waterproof material, to enclose internal piping, as illustrated in FIGS. 11-14. In addition, FIGS. 11-14 reflect a more streamlined shape for the wall plates 112, 114 than that shown in FIG. 9. It will be understood that the present disclosure encompasses assemblies that incorporate wall plates of a range of different suitable shapes.

Thus, as seen in FIG. 11, the first wall plate 112 comprises a distal panel 112a on its shower-facing side and a proximal panel 112b on its wall-facing side. Each panel 112a, 112b has a respective groove 167a, 167b formed therein, the grooves 167a, 167b coming together to form a channel 167 that extends through an interior of the wall plate 112 from a first inlet-outlet hole 175 to a second inlet-outlet hole 177 and retains and substantially encloses proximal piping 166. More particularly, only a pair of opposite inlet-outlet connecting ends of the proximal piping 166 are visible and accessible from the exterior of the proximal panel 112, through the inlet-outlet holes 175, 177. The inlet-outlet holes 175, 177 are formed in the distal first wall plate panel 112a to permit each side mister unit 162 to connect to a respective connecting end of the proximal piping 166 through a respective hole 175, 177, as seen from the distal side in FIG. 9. In addition, aligned holes 171a and 171b are formed in the respective panels 112a, 112b to permit the first shower head unit 118 to connect to a shower head supply line (not shown) at the first shower wall SW1. Another pair of aligned holes 173a, 173b formed in the respective panels 112a, 112b facilitates the alignment of a proximal end of the transfer unit 132, which may include a suitable end cap or end feature as illustrated in FIG. 9 for bracing the transfer unit 132 against the first shower wall SW1 at the position of the holes 173a, 173b.

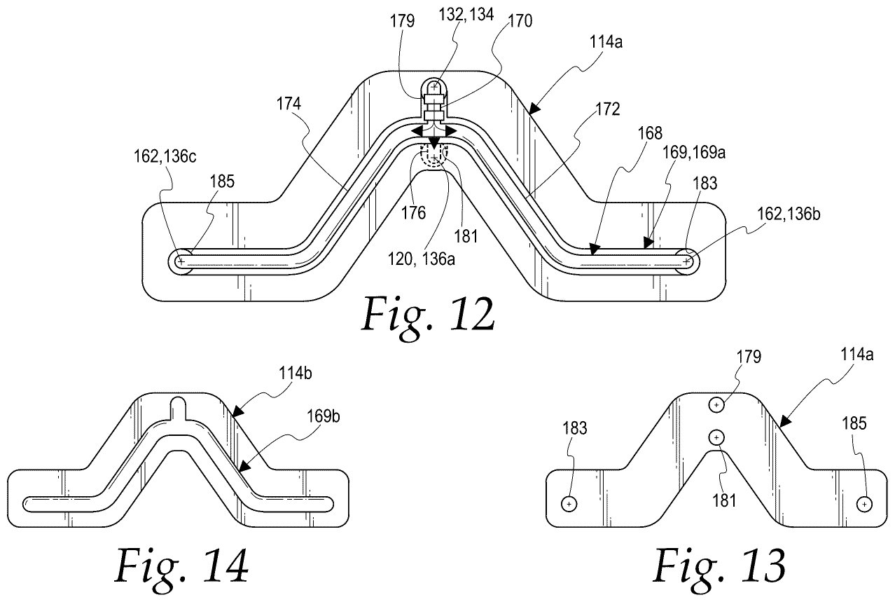

Turning to FIGS. 12-14, there is illustrated a similar clamshell construction of the second wall plate 114 for housing or enclosing internal piping. In particular, the second wall plate 114 is formed of a proximal panel 114a on its shower-facing side and a distal panel 114b on its wall-facing side. A corresponding groove 169a, 169b is formed in each respective panel 114a, 114b, and the grooves come together to form a channel network 169 that connects to an inlet hole 179 and three outlet holes 181, 183, 185. The channel network 169 encloses a four-way piping junction 168. The piping junction 168 is free of internal valves and comprises an inlet stem 170 that connects to the transfer unit 132 at the transfer inlet 134, a first mister outlet branch 172, a second mister outlet branch 174, and a shower outlet branch 176. The first mister outlet branch 172 extends first rightwardly and then at a downward-rightward incline from the inlet stem 170 to connect to the right side mister unit 162 at the first mister outlet 136b, the second mister outlet branch 174 extends first leftwardly and then at a downward-leftward incline from the inlet stem 170 to connect to the left side mister unit 162 at the second mister outlet 136c, and the shower outlet branch 176 extends straight down from the inlet stem 170 to connect to the second shower head unit 120 at the shower outlet 136a. The transfer inlet 134 and the shower and mister outlets 136a, 136b, 136c are aligned with and accommodated by the inlet hole 179 and the outlet holes 181, 183, and 185, respectively.

With reference to FIGS. 9, 11, and 12, it will be understood that, when the valves operated by the valve actuators 125b and 125c are both open, an endless looped flow pathway is formed by the side misters 162, the piping 166 enclosed by the first wall plate 112, and the piping junction 168 enclosed by the second wall plate 114. More particularly, the proximal ends of the side misters 162 are fluidly connected by the piping segment 166 and the distal ends of the side misters 162 are fluidly connected by the first and second mister outlet branches 172, 174 of the four-way piping junction, which come together at the same elevation, raised relative to that of the side misters 162, where each branches off horizontally from the inlet stem 170. A central portion of the piping segment 166 likewise includes a raised horizontal run that extends rightwardly to a downward-rightward inclined run, and leftwardly to a downward-leftward inclined run, the inclined runs leveling off at the elevation of the side mister units 162. Thus, both the piping segment 166 and the piping junction 168 serve to absorb and dampen perturbations in water pressure in the side misters 162, as well as any pressure difference between the two side mister units 162, by allowing water at higher pressure to circulate in either direction around the endless looped flow pathway rather than hitting any dead end stops, as well as allowing higher-pressure water to release some of its energy by flowing up the inclined runs of the piping segment 166 and the piping junction 168. This tends to dampen or eliminate any “water hammer” effects in either side mister unit 162, such as undesired noise, vibration, or other movements.

The preceding description of the disclosure has been presented for purposes of illustration and description and is not intended to be exhaustive or to limit the disclosure to the precise form disclosed. The description was selected to best explain the principles of the present teachings and the practical application of these principles to enable others skilled in the art to best utilize the disclosure in various embodiments and various modifications as are suited to the particular use contemplated. It should be recognized that the words “a” or “an” are intended to include both the singular and the plural. Conversely, any reference to plural elements shall, where appropriate, include the singular.

It is intended that the scope of the disclosure not be limited by the specification but be defined by the claim(s) set forth below. In addition, although narrow claims may be presented below, it should be recognized that the scope of this disclosure is much broader than presented by the claim(s). It is intended that broader claims will be submitted in one or more applications that claim the benefit of priority from this application. Insofar as the description above and the accompanying drawings disclose additional subject matter that is not within the scope of the claim or claims below, the additional disclosures are not dedicated to the public and the right to file one or more applications to claim such additional disclosures is reserved.

What is claimed is:

1. A dual shower head assembly comprising:
a first shower head unit, the first shower head unit comprising a first shower head, the first shower head unit being disposed on a proximal bathroom wall and fluidly connected to a shower supply line;
a transfer unit, the transfer unit being fluidly connected to the first shower head unit between the shower supply line and the first shower head;
a distal wall plate disposed on a distal bathroom wall opposite and spaced in a distal longitudinal direction from the proximal bathroom wall;
distal piping retained by the distal wall plate, the distal piping comprising a transfer inlet, a shower outlet, and a shower feed flow channel extending from the transfer inlet to the shower outlet;
the transfer unit being fluidly connected to the transfer inlet; and
a second shower head unit, the second shower head unit comprising a second shower head and being fluidly connected to the shower outlet.

2. The dual shower head assembly of claim 1, further comprising a proximal wall plate disposed on the proximal bathroom wall, the transfer unit comprising a rigid pipe extending from the distal wall plate to the proximal wall plate.

3. The dual shower head assembly of claim 2, further comprising a top panel structure connected to a top side of each of the proximal wall plate and the distal wall plate.

4. The dual shower head assembly of claim 3, further comprising a light source affixed to a lower side of the top panel structure.

5. The dual shower head assembly of claim 1, further comprising a spacer bar having a proximal end and a distal end, the distal wall plate being disposed between the distal bathroom wall and the distal end of the spacer bar, the spacer bar being disposed between the distal wall plate and the proximal bathroom wall so as to be braced by a bracing force between the proximal bathroom wall and the distal wall plate.

6. The dual shower head assembly of claim 5, further comprising at least one anchor connector, the anchor connector being connected to the spacer bar and to the transfer unit, the anchor connector being adapted and configured to restrain lateral movement of the transfer unit relative to the spacer bar.

7. The dual shower head assembly of claim 6 wherein the transfer unit comprises a flexible hose and the assembly comprises a plurality of said anchor connectors connected to the spacer bar and to the flexible hose.

8. The dual shower head assembly of claim 5, further comprising a proximal wall plate disposed on the proximal bathroom wall, the proximal wall plate receiving a proximal end of the spacer bar.

9. The dual shower head assembly of claim 8 wherein the proximal wall plate is disposed between the proximal end of the spacer bar and the proximal bathroom wall so as to transmit the bracing force from the proximal bathroom wall to the proximal end of the spacer bar.

10. The dual shower head assembly of claim 8 wherein the proximal wall plate has an alignment opening extending longitudinally therethrough, the first shower head unit comprising a first shower arm, the first shower arm being received in the alignment opening to align a lateral position of the proximal wall plate on the proximal bathroom wall.

11. The dual shower head assembly of claim 10 wherein each of the proximal wall plate and the distal wall plate comprises a straight lower edge, the straight lower edge being adapted and configured to engage a horizontally extending top side of a respective shower wall disposed on the corresponding bathroom wall, so as to level and vertically align the respective wall plate on the respective bathroom wall.

12. The dual shower head assembly of claim 1 wherein the distal piping further comprises a first side mister outlet, a second side mister outlet, a first side mister feed flow channel extending from the transfer inlet to the first side mister outlet, and a second side mister feed flow channel extending from the transfer inlet to the second side mister outlet, the assembly further comprising a first side mister unit and a second side mister unit, the first and second side mister units comprising a first longitudinally extending nozzle feed pipe connected to the first side mister outlet and a second longitudinally extending nozzle feed pipe connected to the second side mister outlet, respectively, the first and second longitudinally extending nozzle feed pipes being spaced in opposite lateral directions from the second shower head unit and extending proximally from the distal wall plate toward the proximal bathroom wall, each nozzle feed pipe comprising a nozzle feed flow channel in fluid connection with the corresponding side mister outlet and at least one misting spray nozzle disposed on an outer side of the nozzle feed pipe, the misting spray nozzle being in fluid communication with the nozzle feed flow channel and adapted and configured to deliver misting spray to an area disposed below and between the first and second nozzle feed pipes when water flow is directed through the nozzle feed flow channel.

13. The dual shower head assembly of claim 12, further comprising a proximal wall plate disposed on the proximal bathroom wall and proximal piping, the proximal wall plate retaining the proximal piping, the proximal piping comprising two opposite inlet-outlet ends and a proximal flow channel extending from each of the inlet-outlet ends to the other inlet-outlet end, each of the nozzle feed pipes being connected to one of the inlet-outlet ends of the proximal piping, and each nozzle feed flow channel extending through the length of the corresponding nozzle feed pipe from the corresponding side mister outlet to the proximal flow channel.

14. The dual shower head assembly of claim 13 wherein the first side mister feed flow channel is fluidly connected to the second side mister feed flow channel to form a distal flow channel extending from each of the side mister outlets to the other side mister outlet, such that an endless looped flow pathway is formed which comprises the first and second side mister flow channels, the first nozzle feed flow channel, the proximal flow channel, and the second nozzle feed flow channel, the endless looped flow pathway extending proximally through the first nozzle feed pipe from the distal piping to the proximal piping, laterally through the proximal piping from the first nozzle feed pipe to the second nozzle feed pipe, distally through the second nozzle feed pipe from the proximal piping to the distal piping, and laterally through the distal piping from the second nozzle feed pipe back to the first nozzle feed pipe.

15. The dual shower head assembly of claim 14 wherein the endless looped flow pathway comprises an elevated region in at least one of the proximal flow channel and the distal flow channel, the elevated region being at a higher elevation than the nozzle feed flow channels.
